(19) United States
(12) Patent Application Publication
(10) Pub. No.: US 2013/0015313 A1
(43) Pub. Date: Jan. 17, 2013

(54) ADJUSTABLE SYSTEM

(71) Applicants: Andreas Schmid, Coburg (DE); Marco Gleißberg, Coburg (DE); Alexander Zech, Coburg (DE); Anthony Ferenc, Goodrich, MI (US); Anil Bhat, Farmington Hills, MI (US)

(72) Inventors: Andreas Schmid, Coburg (DE); Marco Gleißberg, Coburg (DE); Alexander Zech, Coburg (DE); Anthony Ferenc, Goodrich, MI (US); Anil Bhat, Farmington Hills, MI (US)

(21) Appl. No.: 13/548,058

(22) Filed: Jul. 12, 2012

Related U.S. Application Data
(60) Provisional application No. 61/579,538, filed on Dec. 22, 2011.

(30) Foreign Application Priority Data
Jul. 16, 2011 (DE) 10 2011 107 595.3
Jan. 30, 2012 (DE) 10 2012 100 715.2

(51) Int. Cl. B60N 2/07

(52) U.S. Cl. 248/429

(57) ABSTRACT

An adjustment system for a motor vehicle seat connected with two rails and shiftable with the two rails is provided. The adjustment system comprises a holding element made of plastics, which is arranged between the two rails, and a reinforcement element which is connected with the holding element.

### CROSS-REFERENCE TO RELATED APPLICATION

This application claims the benefit of U.S. Patent Application No. 61/579,538, filed on Dec. 22, 2011, German Patent Application No. 10 2011 107 595.3, filed on Jul. 16, 2011 and German Patent Application No. 10 2012 100 715.2, filed on Jan. 30, 2012 which are fully incorporated herein by reference.

### BACKGROUND

Adjustment System for a Motor Vehicle Seat.

This invention relates to an adjustment system for a motor vehicle seat connected with two rails and shiftable with the two rails. Such seats are widely known from practice. Two (upper) rails are arranged under a motor vehicle seat and two further (lower) rails are mounted on a vehicle floor for guiding the upper rails.

From DE 198 15 283 A1 and DE 10 2007 027 322 A1 adjustment systems are known, in which a holding element is arranged between the two rails connected with the motor vehicle seat. The holding element on the one hand increases the stability of the adjustment system, supports the synchronization of the movement of the two rails and on the other hand serves to carry an electric motor and drive shafts. By means of the electric motor and the drive shafts the synchronous drive for adjusting the seat rails is effected.

According to DE 198 15 283 A1, the holding element is made of sheet steel and therefore relatively heavy. The holding element according to DE 10 2007 027 322 A1 is made of plastics and, to achieve a sufficient stability, designed extremely thick-walled and with many ribs, which likewise leads to a high weight.

### SUMMARY

It is the object of the present invention to create an adjustment system as mentioned above, which is lightweight, but sufficiently withstands the loads.

A holding element connecting the rails is made of plastics, as is known per se. It is, however, designed considerably simpler and lighter than known. The part of the holding element made of plastics is dimensioned such that it substantially can withstand the tensile forces occurring between the rails, but must hardly absorb bending forces, whereby great weight advantages can be achieved. To absorb the bending forces directed transverse to the orientation of the rails, a reinforcement element made of a more stable material (metal, carbon fiber, more rigid plastics) is connected with the holding element. The reinforcement element can optimally be designed for a bending load and hence can be shaped particularly easily. In a synopsis of the components holding element and reinforcement element a surprisingly clear weight advantage can be achieved as compared to the prior art, with the load-bearing capacity of the adjustment system being high. In particular, advantages over conventional holding elements can be achieved by the reinforcement part chiefly designed for bending loads.

As is known, the holding element can be designed as an injection-molded plastic part and can be provided with reinforcement ribs, wherein these reinforcement ribs advantageously are also formed for accommodating and fixing the reinforcement part. The reinforcement ribs thus designed as holding ribs accommodate the reinforcement part on its circumferential surface and clamp the same. During manufacture, the reinforcement part thus can be clipped between the holding ribs of the holding element in a simple way. In addition, it is possible that the reinforcement element also is clamped at the holding element on at least one of its axial ends, which during manufacture is possible for example by introducing the reinforcement element into a pocket of the holding element.

For clipping the reinforcement element into the holding element it is required that the holding ribs include insertion openings for accommodating the reinforcement element. The holding element advantageously should be designed such that in the mounting position of the holding element these insertion openings are open at the bottom, i.e. in direction of the vehicle floor. When a vehicle seat (with the adjustment system according to the invention) which is mounted, but not yet installed in the vehicle, is loaded, this is primarily effected from below. In case the holding element is elastically bent between the rails (to the top), an automatic clipping out of the reinforcement element cannot occur. If a main load from a direction other than from below must be expected, clipping the reinforcement element into the holding element should be effected from this direction, i.e. the insertion openings should point against the loading direction.

Of course, however, it can also be provided that the holding element is clipped to the reinforcement element. The reinforcement element for example can be a functional or control element of the adjustment system, to which the holding element can be mounted subsequently. An example in particular would be a linkage part for releasing a latch of the adjustment system which fixes the shiftable motor vehicle seat in an adopted pushing position. Such linkage part regularly is connected with both rails and adjustably, in particular rotatably mounted, wherein by displacement of the linkage part a latch can be released, in order to permit shifting of the motor vehicle seat along the longitudinal direction of the rails. A pushing or longitudinal position of the motor vehicle seat thus can be varied by a user by shifting the linkage part.

In particular in such exemplary embodiment it can be provided that the holding element includes at least one retaining rib which engages around a portion of the reinforcement element. For this purpose, a retaining rib for example protrudes on one side of the holding element in an L-shaped manner. In this way, the holding element can be clipped comparatively quickly and easily for example to a reinforcement element already mounted on rails.

To ensure a rattle-free connection between holding element and reinforcement element, in particular when using at least one L-shaped retaining rib, at least one clamping element can be provided on the holding element, which urges against the reinforcement element. Such clamping element preferably constitutes an elastic pressure tongue which during the connection of holding element and reinforcement element is displaced against a restoring force and in the connected condition of holding element and reinforcement element hence urges against the reinforcement element, so that the retaining rib engaging around the reinforcement element is elastically supported on the reinforcement element. It can thus be ensured that the holding element is safely retained and even in driving operation no undesired rattling noise is produced by the plastic holding element possibly striking against the reinforcement element—for example made of metal.

Exemplary, the at least one clamping element or also a plurality of clamping elements is integrally formed with the holding element.

As an alternative to the aforementioned design with clipped-in reinforcement element, the reinforcement element also can be molded into the material of the holding element, for example be completely overmolded.

In a further exemplary embodiment of the invention it is provided that the reinforcement element has a closed tubular cross-section, or a T- or double-T structure. The reinforcement element hence has a high moment of resistance, can bear a high bending load and hence can be designed quite particularly lightweight.

The reinforcement element exemplary is arranged in longitudinal direction of the holding element, i.e. transverse to the orientation of the rails in the holding element, and should preferably be longer than half the length of the holding element (length of the holding element between its means for attachment to the rails known per se). Thus, the reinforcement element can safely contribute to the bending stability of the holding element.

In an alternative exemplary design variant, the reinforcement element is connected with both rails and the holding element is connected with one rail only (unilaterally) and in addition with the reinforcement element. Here, the holding element preferably has a length which is smaller than half the distance between the two rails, so that the holding element extends along the reinforcement element over only a part of the reinforcement element extending between the two rails. Here, the holding element consequently extends from one rail only up to maximally the middle of the space defined between the two rails.

In one exemplary design variant at least two holding elements are provided. These holding elements either are connected with a common reinforcement element or each are connected with one associated reinforcement element each of at least two reinforcement elements. In the first-mentioned case, for example two holding elements located opposite each other can be fixed on one rail each (unilaterally) and be connected with a common reinforcement element, e.g. a single linkage part.

As is known per se, the holding element can include receptacles for an electric motor and/or for a wire harness and/or for an electronic control unit and/or guideways for at least one drive shaft. The holding element in particular can form a plurality of fixing points for fixing means for the proper fixation of an electric motor, a wire harness and/or an electronic control unit.

In an advantageous aspect of the invention, the electric motor for example can also be screwed to the reinforcement element. For this purpose a through bore for a screw must be provided in the holding element, and this screw can be screwed into a threaded bore of the reinforcement element. In this way, not only the electric motor is fixed, but the reinforcement element is secured at the holding element. Thus, it cannot automatically be detached from the holding element.

### BRIEF DESCRIPTION OF THE DRAWINGS

Further details of the invention can be taken from the following description of exemplary embodiments.

FIG. 1: shows an adjustment system according to the invention in a perspective top view.

FIG. 2: shows a portion of a holding element without reinforcement element in a perspective view from below.

FIG. 3: shows a holding element with reinforcement element in a perspective view from below.

FIG. 4: shows a further design variant of an adjustment system according to the invention with modified holding element in a perspective top view.

### DETAILED DESCRIPTION

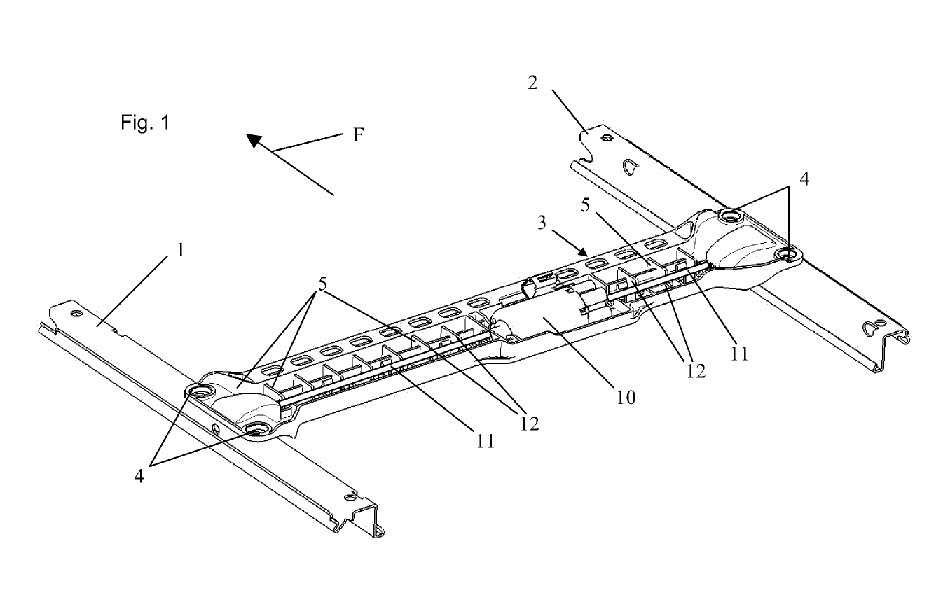

In FIG. 1, a part of the adjustment system according to the invention is shown in an overview. In the adjustment system disposed in the mounting position, the view in FIG. 1 is effected in a perspective from above. There are shown two seat rails 1, 2, on which a non-illustrated vehicle seat can be mounted. To each of the seat rails 1, 2 a further, likewise non-illustrated lower rail belongs, which is fixed at the vehicle floor. On these lower rails, the adjustment system with the rails 1, 2 and the vehicle seat chiefly is shiftable in longitudinal direction F of the vehicle.

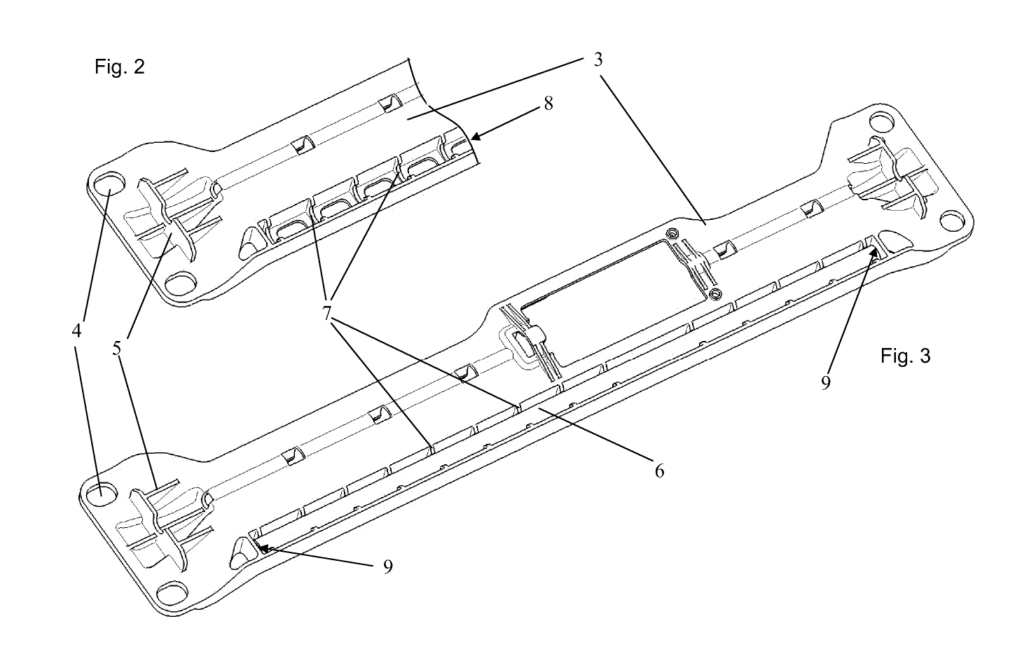

Between the two rails 1, 2 and approximately transverse to the longitudinal direction F of the vehicle a holding element 3 is arranged. On both sides, it includes means 4 for fixation at the rails 1, 2. In the exemplary embodiment, these are openings through which the holding element 3 can be screwed or riveted to the rails 1, 2. The holding element 3 is designed as an injection-molded plastic part and includes reinforcement ribs 5. By this material selection and shaping, a low weight of the holding element 3 can be achieved, but it is not designed to withstand all loads alone in operation. As is shown in FIGS. 2 and 3 from the bottom side of the holding element 3, a reinforcement element 6 is connected with the holding element 3. In the exemplary embodiment, it is designed as steel tube with round cross-section. It might, however, also have other cross-sectional shapes adapted to the load, such as a T- or double-T cross-section, or be made of a solid material with round or angular cross-section. The advantage of the tube is its large moment of resistance with a low weight. In the exemplary embodiment, the reinforcement element 6 is clipped into the holding element 3 from below.

As shown in FIGS. 2 and 3, the holding element 3 includes retaining ribs 7 which have openings at the bottom. The holding ribs 7 define openings whose lower width is slightly smaller than the diameter of the reinforcement element 6. Thus, a channel 8 is obtained for the reinforcement element 6, which also defines the exact mounting position of the reinforcement element 6. The channel 8 also includes walls 9 by which the ends of the reinforcement element 6 are held in the mounting position. With another design of the holding element 3, the walls 9 might also be designed such that the ends of the reinforcement element 6 are clipped axially—for example by protrusions of the walls 9 engaging in the tube ends of the reinforcement element 6.

The reinforcement element 6 mounted in the holding element 3 ensures that the holding element 3 now withstands all loads in operation. The reinforcement element 6 now in particular absorbs bending forces, of which a holding element 3 of the same shape, but without reinforcement element 6, would not be capable. A holding element exclusively made of plastics would be much heavier and would require more installation space than the combination of holding element 3 and reinforcement element 6. Due to the fact that the reinforcement element 6 is inserted into the holding element 3 from below, it cannot automatically be detached from the holding element 3 in the case of loads of the adjustment system which are chiefly exerted from below.

In another embodiment of the invention, the reinforcement element 6 might also be overmolded with the plastic material of a holding element. The length of the reinforcement element 6 can be chosen minimized corresponding to the loads. It should, however, at least be half as large as the distance between the means 4 for fixing the holding element 3 at the rails 1, 2.

FIG. 1 shows that an electric motor 10 also is mounted on the holding element 3 and two drive shafts 11 are guided on the same. Due to the torque of the electric motor 10 exerted via the drive shafts 11, the rails 1, 2 are shifted on the lower rails upon activation of the electric motor 10, whereby a longitudinal adjustment of the vehicle seat is effected. For this purpose, the holding element 3 also includes openings for fixing the electric motor 10 and guideways 12 for the drive shafts 11.

In another embodiment of the invention, the electric motor 10 also might be screwed through the holding element 3 to the reinforcement element 6 located thereunder. It would thus be achieved that a simultaneous fixation of the electric motor 10 and securement of the reinforcement element 6 to the holding element 3 is effected.

The design of the holding element 3 according to the invention with the reinforcement element 6 and the electric motor 10 and the drive shafts 11 is found to be quite particularly lightweight, but at the same time also particularly stable with all loads of the adjustment system. The holding element chiefly absorbs tensile forces transverse to the longitudinal direction of the vehicle and carries the electric motor 10. The reinforcement element 6, however, absorbs bending forces occurring with minimal weight.

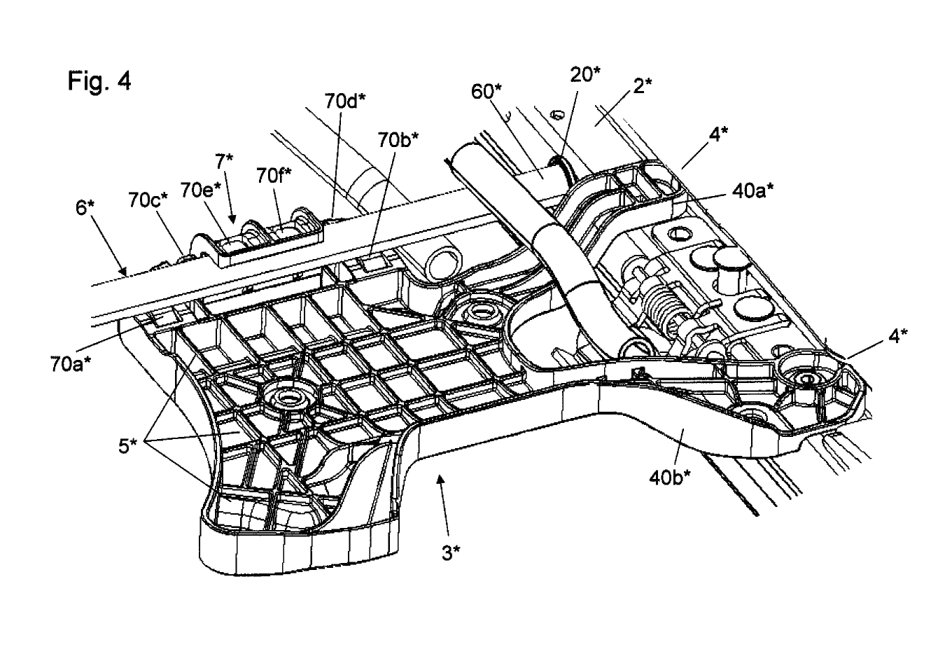

FIG. 4 illustrates a further variant of an adjustment system according to the invention in a perspective top view. In FIG. 4, merely one of the two rails, here a rail 2*, is shown, to which a holding element 3* is fixed via two (fixing) means 4*.

The holding element 3* merely is unilaterally connected with the rails located opposite each other in parallel, i.e. only fixed to the rail 2* and not, like the holding element 3 of the preceding FIGS. 1 to 3, to both rails 1, 2. The holding element 3* thus does not connect both rails of the adjustment system with each other, but here extends maximally up to the middle of the space between the two rails. The holding element 3* thus has a length which is smaller than half the distance between the two rails, of which merely the rail 2* is shown in FIG. 4.

The holding element 3* also is made of a plastic material and connected with a reinforcement element 6* of a more rigid material. In the present case, the reinforcement element is formed by a linkage part 6* by means of which a latch for locking the motor vehicle seat in a pushing or longitudinal position can be released. In FIG. 4, the linkage part 6* constitutes a hollow cylindrical tube which at one tube end each is connected with both rails. In FIG. 4, this is illustrated by the support of a tube end 60* of the linkage part 6* on a connecting point 20* of the rail 2*.

The linkage part 6* here is shiftably mounted on both rails in a manner known per se, so that a user can shift the linkage part 6*, in order to release a latch of the adjustment system and provide for a longitudinal displacement of the motor vehicle seat. Usually a latch is provided for this purpose, by which a shiftably guided upper rail is locked at a floor-mounted lower rail of the adjustment system. The linkage part 6* preferably is actuatable by a user on a front side of the vehicle seat below a seating surface or cooperates with a corresponding actuating element for shifting the linkage part 6*, in order to release this latch, if necessary.

A part of such latch is shown in FIG. 4 on the rail 2* between two longitudinally extending fixing arms 40a* and 40b* of the holding element 3*. Each of the fixing arms 40a*, 40b* includes a fixing point for a fixing means 4*. Here, the holding element 3* hence is formed such that two fixing points of the holding element 3* relative to the longitudinal extension of the rail 2* are axially spaced from each other such that between the same a locking mechanism of the adjustment system is arranged for locking the rail 2* and for securing an adopted pushing or longitudinal position of the motor vehicle seat.

In addition, the holding element 3* of FIG. 4 also is provided with a plurality of reinforcement ribs 5* on its upper side facing away from the vehicle floor, in order to increase the strength of the holding element 3*.

To avoid that bending forces occurring at the adjustment system must (exclusively) be absorbed by the holding element 3* also in this exemplary embodiment, the holding element 3* furthermore is connected with the reinforcement element in the form of the linkage part 6*. For this purpose, an L-shaped retaining rib 7* protrudes from the holding element 3* on an upper side of the circumferential surface of the holding element 3*, which engages around a portion of the linkage part 6*. The enclosed portion of the reinforcement element 6* is held at the retaining rib 7*, so that the holding element 3* is fixed at the linkage part 6*.

The holding element 3* is formed such that with the linkage part 6* already mounted on the rails, it can be clipped to the linkage part 6* via the retaining rib 7*. For this purpose, the holding element 3* forms clamping elements integrally formed therewith in the form of a plurality of pressure tongues 70a* to 70r. These pressure tongues 70a* to 70f* in part each are elastically shiftable in direction of the lower side of the holding element 3* and are formed on the upper side of the holding element 3*, from which the retaining rib 7* protrudes in an L-shaped manner (pressure tongues 70a*, 70b*, 70c* and 70d*). Another part of pressure tongues 70e* and 70f* are formed on an (upper) leg of the retaining rib 7*, which extends at a distance and substantially parallel to the upper side of the holding element 3*. These pressure tongues 70e*, 70f* are formed such that when holding element 3* and linkage part 6* are connected, they can elastically be shifted substantially to the top, i.e. away from the upper side of the holding element 3* in direction of a seat part carrying the seat cushion.

When clipping the holding element 3* to the linkage part 6*, the pressure tongues 70a* to 70f* thus each are shiftable against a restoring force in direction of the lower side of the holding element 3* or opposite thereto, so that with the linkage part 6* inserted into the retaining rib 7* they urge against the linkage part 6*. Pressure tongues 70a* to 70d* located axially on the outside with respect to a direction of longitudinal extension of the linkage part 6* urge against the linkage part 6* from below in a first direction of action, while the pressure tongues 70e* and 70f* arranged centrally thereto urge against the linkage part 6* from above in an opposite direction of action. The holding element 3* thus (exclusively) rests against the linkage part 6* via the pressure tongues 70a* to 70f*. As a result, the holding element 3* is safely retained at the linkage part 6*, when the linkage part 6* properly rests against the plurality of (here six) elastic pressure tongues 70a* to 70f* of the holding element 3*. The holding element 3* thus elastically supports on the linkage part 6* via its pressure tongues 70a* to 70f*, so that due to the elasticity of the pressure tongues 70a* to 70f* a displacement of the linkage part 6* with the holding element 3* attached thereto still is possible.

In addition to the two supporting arms 40a*, 40b* and the retaining rib 7*, the holding element 3* here also forms further functional regions on its upper side, such as receptacles on which functional components of the adjustment system can be mounted. The holding element 3* here in particular includes a plurality of receptacles for a wire harness and an electronic control unit. These receptacles are provided on the upper side on a flat portion of the holding element 3* provided with the reinforcement ribs 5*. Furthermore, the holding element 3* here forms fixing points for corresponding fixing means, via which said functional components can properly be fixed at the holding element 3*. In the exemplary embodiment of FIG. 4, these are bores on the upper side of the holding element 3*. The holding element 3* thus carries functional components of the adjustment system and in particular includes fixing points for a wire harness and/or individual cables for the electronics of the adjustment system.

Via the connection of the holding element 3* to the linkage part 6* in addition to its fixation at the rail 2*, the holding element 3* (like the holding element 3 of the preceding FIGS. 1 to 3) is designed particularly strong and stable, without having to manufacture the same itself of a more rigid material. The tool-free fixation of the holding element 3* at the linkage part 6* in addition allows a fast assembly. Moreover, by providing clamping elements—here in the form of pressure tongues 70a* to 70f*—it is achieved in a simple way that even in driving operation the holding element 3* rests against the reinforcement element in the form of the linkage part 3* without rattling. At the same time, the linkage part 6* remains shiftable for releasing a latch of the adjustment system.

1. An adjustment system for a motor vehicle seat connected with two rails and shiftable with the two rails, comprising
a holding element arranged between the two rails,
wherein the holding element is made of plastics and a reinforcement element is connected with the holding element.

2. The adjustment system according to claim 1, wherein the reinforcement element is made of metal, carbon fiber or a plastic material and has a higher strength than the holding element.

3. The adjustment system according to claim 1, wherein the holding element is an injection-molded plastic part and includes reinforcement ribs.

4. The adjustment system according to claim 1, wherein the reinforcement element constitutes a functional or control element of the adjustment system, in particular a linkage part for releasing a latch of the adjustment system, which fixes the shiftable motor vehicle seat in an adopted pushing position.

5. The adjustment system according to claim 1, wherein the reinforcement element is clamped on its circumferential surface and/or on at least one of its axial ends by means of at least one retaining rib of the holding element.

6. The adjustment system according to claim 5, wherein the at least one retaining rib engages around a portion of the reinforcement element and/or is formed L-shaped.

7. The adjustment system according to claim 5, wherein a plurality of retaining ribs are provided and the retaining ribs of the holding element are open at the bottom for clamping the reinforcement element on its circumferential surface in mounting position.

8. The adjustment system according to claim 3, wherein the reinforcement element is overmolded with the material of the holding element.

9. The adjustment system according to claims 1, wherein the reinforcement element consists of a tubular carrier or of a carrier with a T- or double-T structure.

10. The adjustment system according to claim 1, wherein the holding element includes means for connection with the rails on one or on both sides.

11. The adjustment system according to claim 10, wherein the reinforcement element is arranged about centrally and oriented in longitudinal direction of the holding element within the holding element and has a length which is greater than half the distance between the means for connection with both rails.

12. The adjustment system according to claim 10, wherein the reinforcement element is connected with both rails and
the holding element is connected with only one rail and the reinforcement element and/or
the holding element has a length which is smaller than half the distance between the two rails, so that the holding element extends along the reinforcement element over only a part of the reinforcement element extending between the two rails.

13. The adjustment system according to claim 10, wherein at least two holding elements are provided, which are connected with one common reinforcement element or which each are connected with one associated reinforcement element each of at least two reinforcement elements.

14. The adjustment system according to claim 1, wherein the holding element includes receptacles for an electric motor and/or for a wire harness and/or for an electronic control unit and/or guideways for at least one drive shaft.

15. The adjustment system according to claim 14, wherein the holding element includes at least one bore and the reinforcement element includes at least one threaded bore and the reinforcement element is clamped between the electric motor and the holding element by means of a screw connection guided from the electric motor through the bore into the threaded bore.
